(19) United States
(12) Patent Application Publication
(10) Pub. No.: US 2008/0267269 A1
(43) Pub. Date: Oct. 30, 2008

(54) METHOD AND APPARATUS FOR TRANSMITTING REFERENCE SIGNALS

(75) Inventors: Mihai H. Enescu, Helsinki (FI); Chun Yan Gao, Beijing (CN)

Correspondence Address: BRAKE HUGHES BELLERMANN LLP, c/o INTELLEVATE, P.O. BOX 52050, MINNEAPOLIS, MN, 55402, US

(73) Assignee: Nokia Corporation, Espoo (FI)

(21) Appl. No.: 12/107,184

(22) Filed: Apr. 22, 2008

Related U.S. Application Data
(60) Provisional application No. 60/915,084, filed on Apr. 30, 2007.
(60) Provisional application No. 60/917,588, filed on May 11, 2007.

(51) Int. Cl. H04B 1/38; H04L 27/28

(52) U.S. Cl. 375/219; 375/260

(57) ABSTRACT

Disclosed herein is a method which may include determining whether to include a sounding reference signal or a demodulation reference signal within a variable block of a subframe, and transmitting the subframe from a wireless node to an infrastructure node. The subframe may include a plurality of blocks, each block including a plurality of subcarriers.

### PRIORITY CLAIM

This Application claims the benefit of priority of U.S. Provisional Patent Application No. 60/915,084, filed Apr. 30, 2007, entitled “Method and Apparatus for Transmitting Reference Signals,” and U.S. Provisional Patent Application No. 60/917,588, filed May 11, 2007, entitled “Method and Apparatus for Transmitting Reference Signals,” the disclosures of both of which are incorporated by reference.

### BACKGROUND

In transmitting signals over a wireless media, reference signals may be transmitted or provided in some cases to provide information that may be used for coherent demodulation/detection, to assist in channel quality estimation, to assist with channel dependent scheduling, or for other purposes. However, the transmission of reference signals may reduce the bandwidth available for transmitting data. Therefore, it may be desirable to provide a technique that allows reference signals to be more efficiently transmitted.

### SUMMARY

According to one embodiment, a method may include determining whether to include a sounding reference signal or a demodulation reference signal within a variable block of a subframe, and transmitting the subframe from a wireless node to an infrastructure node. The subframe may include a plurality of blocks, each block including a plurality of subcarriers. The subframe may also include either the sounding reference signal or the demodulation reference signal within the variable block based on the determining.

According to another embodiment, a method may include determining whether to include two demodulation reference signals or one demodulation reference signal in a subframe, and transmitting the subframe from a wireless node to an infrastructure node. The subframe may include either two demodulation reference signals or one demodulation reference signal based on the determining.

According to another embodiment, a method may include determining, at an infrastructure node, a signal to be included within a variable block of a subframe, transmitting an instruction from the infrastructure node to a wireless node in a wireless network indicating the determined signal, and receiving, at the infrastructure node from the wireless node based on the transmitting, a subframe. The signal within the variable block may include either a sounding reference signal or a demodulation reference signal. The subframe may include a plurality of blocks, each block including a plurality of subcarriers, and may include the determined signal in the variable block, and may also include one or more additional blocks.

According to another embodiment, a method may include receiving an instruction at a wireless node from an infrastructure node and transmitting a subframe from the wireless node to the infrastructure node. The instruction may indicate a signal as either a demodulation reference signal or a sounding reference signal to be included in a variable block of a subframe. The subframe may include a plurality of blocks, including the variable block, each block including a plurality of subcarriers. The subframe may also include either a demodulation reference signal or a sounding reference signal in the variable block based on the instruction, a demodulation reference signal in a dedicated demodulation reference signal block of the subframe, and data in one or more additional blocks of the subframe.

According to another embodiment, an apparatus may be configured to determine whether to include a sounding reference signal or a demodulation reference signal within a variable block of a subframe and to transmit the subframe from a wireless node to an infrastructure node. The subframe may include a plurality of blocks, each block including a plurality of subcarriers. The subframe may also include either the sounding reference signal or the demodulation reference signal within the variable block based on the determination.

According to another embodiment, an apparatus may include a controller and a transceiver. The controller may be configured to determine whether to include a sounding reference signal or a demodulation reference signal within a variable block of a subframe, the subframe including a plurality of blocks, each block including a plurality of subcarriers. The transceiver may be configured to transmit the subframe to an infrastructure node, the subframe including either the sounding reference signal or the demodulation reference signal within the variable block based on the determination.

According to another embodiment, a method may include transmitting a subframe from a wireless node to an infrastructure node. The subframe may include a plurality of blocks, each block including a plurality of subcarriers. The plurality of blocks may include a dedicated demodulation reference signal block and a sounding reference signal block. The sounding reference signal block may include sounding reference signals in less than all of the plurality of subcarriers included in the sounding reference signal block.

According to another embodiment, a method may include receiving a subframe at an infrastructure node from a wireless node. The subframe may include a plurality of blocks, each block including a plurality of subcarriers. The subframe may include a dedicated demodulation reference signal block and a sounding reference signal block. The method may further include using information included in the sounding reference signal block to demodulate data signals included in the plurality of blocks.

The details of one or more implementations are set forth in the accompanying drawings and the description below. Other features will be apparent from the description and drawings.

### BRIEF DESCRIPTION OF THE DRAWINGS

FIG. 1 is a block diagram illustrating a wireless network according to an example embodiment.

FIG. 2A shows a block diagram of an uplink subframe according to an example embodiment.

FIG. 2B shows a block diagram of the uplink subframe in which a variable block includes a sounding reference signal, according to an example embodiment.

FIG. 2C shows a block diagram of the uplink subframe in which the variable block includes a demodulation reference signal, according to an example embodiment.

FIG. 2D shows a block diagram of the uplink subframe in which the variable block includes data, and the fifth block includes the demodulation reference signal, according to an example embodiment.

FIG. 2E is a block diagram of the uplink subframe in which the second and eighth blocks include demodulation reference signals.

FIG. 3 is a block diagram of a frame including subframes according to an example embodiment.

FIG. 4 is a block diagram of a frame according to another example embodiment.

FIG. 5 is a block diagram of a frame according to another example embodiment.

FIG. 6 is a flowchart showing a method according to an example embodiment.

FIG. 7 is a flowchart showing a method according to another example embodiment.

FIG. 8 is a flowchart showing a method according to another example embodiment.

FIG. 9 is a flowchart showing a method according to another example embodiment.

FIG. 10 is a block diagram illustrating an apparatus that may be provided in a node according to an example embodiment.

FIG. 11A is a block diagram showing the uplink subframe according to an example embodiment in which the uplink subframe includes one dedicated demodulation reference signal block and one sounding reference signal block.

FIG. 11B is a block diagram showing the uplink subframe according to an example embodiment in which the sounding reference signal block has a greater bandwidth than the other blocks included in the plurality of blocks.

FIG. 12 is a block diagram showing a plurality of subframes each transmitted by a different wireless node, according to an example embodiment.

FIG. 13 is a block diagram showing a plurality of subcarriers along which a plurality of wireless nodes using a repetition factor greater than one may transmit sounding reference signals, according to an example embodiment.

FIG. 14 is a flowchart showing a method according to an example embodiment.

FIG. 15 is a flowchart showing a method according to another example embodiment.

FIG. 16A is a block diagram showing the uplink subframe according to an example embodiment in which the variable block includes a sounding reference signal(s).

FIG. 16B is a block diagram showing the uplink subframe according to an example embodiment in which the uplink subframe includes two dedicated demodulation reference signal blocks, and the variable block includes a data signal(s).

FIG. 16C is a block diagram showing the uplink subframe according to an example embodiment in which the uplink subframe includes two dedicated demodulation reference signal blocks and the variable block is empty, or does not include a signal.

FIG. 16D is a block diagram showing the uplink subframe according to an example embodiment in which the uplink subframe includes one dedicated demodulation reference signal block and the variable block includes a sounding reference signal.

FIG. 16E is a block diagram showing the uplink subframe according to an example embodiment in which the uplink subframe includes one dedicated demodulation reference signal block, and the variable block includes a data signal(s).

FIG. 16F is a block diagram showing the uplink subframe according to an example embodiment in which the uplink subframe includes one dedicated demodulation reference signal block, and the variable block is empty, or does not include a signal.

FIG. 17 is a flowchart showing a method according to an example embodiment.

FIG. 18 is a flowchart showing a method according to another example embodiment.

FIG. 19 is a flowchart showing a method according to another example embodiment.

FIG. 20 is a flowchart showing a method according to another example embodiment.

FIG. 21 is a flowchart showing a method according to another example embodiment.

FIG. 22 is a flowchart showing a method according to another example embodiment.

### DETAILED DESCRIPTION

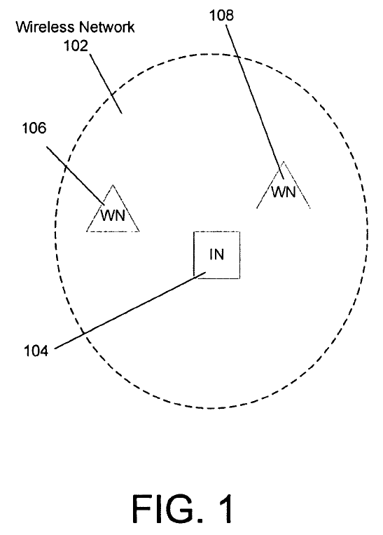

Referring to the Figures in which like numerals indicate like elements, FIG. 1 is a block diagram illustrating a wireless network 102 according to an example embodiment. The wireless network 102 may include a number of wireless nodes or stations, such as an infrastructure node (IN) 104, base station, or access point, and one or more wireless nodes (WN) 106, 108 or mobile stations. While only one infrastructure node 104 and two wireless nodes 106, 108 are shown in the wireless network 102, any number of infrastructure nodes 104 and wireless nodes 106, 108 may be provided. Each station in the network 102, such as the wireless nodes 106, 108, may be in wireless communication with the infrastructure node 104, and may even be in direct communication with each other. Although not shown, the infrastructure node 104 may be coupled to a fixed network, such as a Local Area Network (LAN), Wide Area Network (WAN), the Internet, etc., and may also be coupled to other wireless networks.

The various embodiments described herein may be applicable to a wide variety of networks and technologies, such as WLAN networks (e.g., IEEE 802.11 type networks), IEEE 802.16 WiMAX networks, cellular networks, radio networks, or other wireless networks. The various embodiments may also be applied, for example, to technologies or networks related to or based on 3^{rd} Generation Partnership Project (3GPP) Technical Specification Group Radio Access Network (3GPP TSG RAN), or related to or based on the Long Term Evolution (LTE) of Universal Terrestrial Radio Access Network (UTRAN), or other specifications or technologies, for example. In another example embodiment, the various examples and embodiments may be applied, for example, to a mesh wireless network, where a plurality of mesh points (e.g., access points or wireless nodes) may be coupled together via wired or wireless links. The various embodiments described herein may be applied to wireless networks, both in an infrastructure mode where an infrastructure node 104 may communicate with a wireless node 106 (i.e., communication occurs through infrastructure nodes 104), as well as an ad hoc mode in which wireless nodes 106, 108 may communicate directly via a peer-to-peer network, for example.

The terms “wireless node” or “node” or the like may include, for example, a wireless station, an access point or base station, a wireless personal digital assistant (PDA), a cell phone, an 802.11 WLAN phone, a wireless mesh point, or any other wireless device. For example, the wireless nodes 106, 108 may include mobile stations or mobile nodes, user terminals, mobile cell phones or other wireless devices, although not limited thereto. An infrastructure node (such as IN 104) may include a base station (BS), an access point (AP), an access gateway (AG), a Node B, a relay node (RN) or relay station, as examples. These are merely a few examples of the wireless devices that may be used to implement the various embodiments described herein, and this disclosure is not limited thereto.

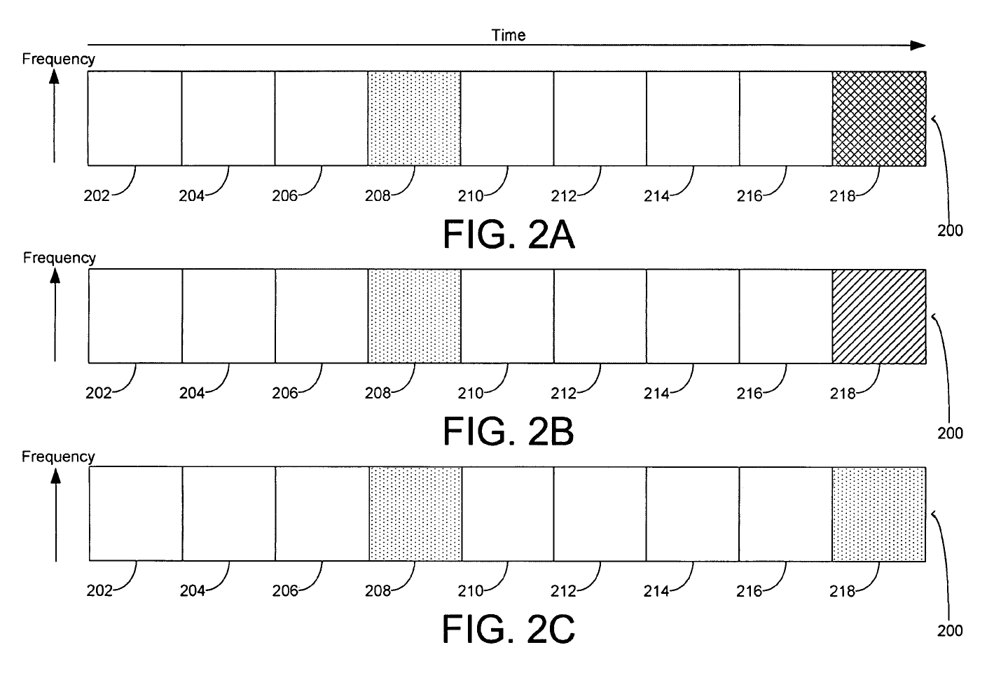

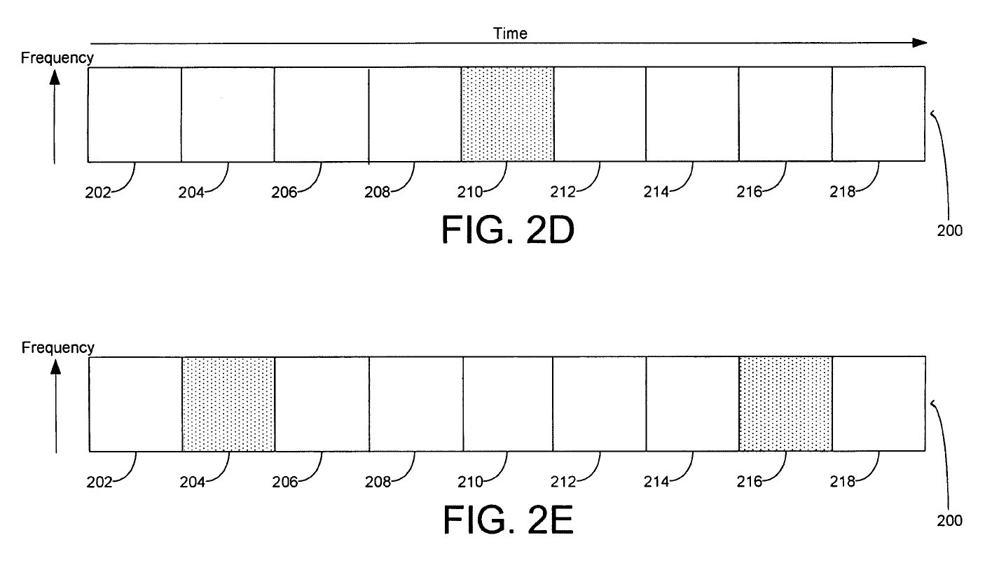

In an example embodiment, the infrastructure node 104 may communicate with the wireless nodes 106, 108 in a time division duplexing (TDD) mode. In TDD mode, the communication may be made by frames including subframes, with some of the subframes transmitting information from the infrastructure node 104 to one or more of the wireless nodes 106, 108 (downlink mode or downlink direction), and the remaining subframes transmitting information from one of the wireless nodes 106, 108 to the infrastructure node 104 (uplink mode or uplink direction). The frames and subframes are discussed in further detail with reference to FIGS. 2-5.

The infrastructure node 104 and wireless nodes 106, 108 may communicate in a number of different frequency bands, such as, for example, 2.6 GHz. A number of modulation schemes may be used, such as binary phase shift keying (BPSK), quadrature phase shift keying (QPSK), or orthogonal frequency division multiple access (OFDM), etc.

The signals transmitted to the infrastructure node 104 from the wireless nodes 106, 108 may include reference signals. For example, each subframe may include a plurality of blocks, with each block including a plurality of subcarriers. For example, each block may include an OFDM (orthogonal frequency division multiplex) symbol, or single carrier frequency division multiple access signal, across twelve (or other number of) subcarriers. A reference signal, or data, may be provided in each of the blocks within a subframe, for example. The reference signal(s) may be included in some or all of the frequency subcarriers, and may be limited to certain timeslots within a frame or subframe sent from the wireless nodes 106, 108 to the infrastructure node 104.

A number of different types of reference signals may be transmitted or provided in a block (or blocks) of a subframe. For example, reference signals that may be included in one or more blocks of a subframe may include a sounding reference signal and a demodulation reference signal. These reference signals may be provided, for example, by a wireless node to an infrastructure node (in the uplink direction).

A sounding reference signal may, for example, be used for uplink channel quality (state) estimation and/or for uplink channel dependent scheduling. A sounding reference signal may be a signal or information, such as (for example) channel state information, to allow the receiving node to perform channel-dependent scheduling, for example. This may involve, for example, an infrastructure node receiving a sounding reference signal, and then scheduling or assigning one or more uplink channels that may have good quality to users or wireless nodes for uplink communication to the infrastructure node. For example, the sounding reference signal may be used by an infrastructure node for uplink channel quality estimation for channel dependent scheduling. Thus, the sounding reference signal may allow uplink frequency and/or time-domain channel dependent scheduling.

A demodulation reference signal may include information or signals that may be used by the receiving node (such as an infrastructure node) for demodulation/detection, such as coherent demodulation/detection. These are merely some examples. In one example, the need for additional demodulation reference signals may increase, for example, with a speed of the wireless node 106 relative to the infrastructure node 104.

FIG. 2A shows a block diagram of an uplink subframe 200 according to an example embodiment. The uplink subframe 200 may include a plurality of blocks 202-218, such as nine long blocks. The blocks 202-218 may be transmitted consecutively. As suggested by the arrow labeled, “Time”, the blocks 202-218 may each occupy different time slots. The time slots occupied by the blocks 202-218 may be consecutive, according to an example embodiment.

The blocks 202-218 may each comprise a plurality of carriers, such as OFDM subcarriers. For example, the blocks 202-218 may each include a long block with approximately equal bandwidths, and/or an equal number of subcarriers, such as twelve subcarriers. Each of the subcarriers may have approximately equal bandwidths, such as fifteen kHz, for a block bandwidth of 180 kHz for the example of twelve subcarriers per block. In a further example embodiment, the uplink subframe 200 may have a duration or period of 0.675 milliseconds (ms), 1 ms, or other value, with each of the blocks 202-218 having an approximately equal duration or period, such as one-ninth of the duration or period of the uplink subframe 200.

The blocks 202-218 may include blocks that include data, and blocks which include reference signals. For example, a dedicated demodulation reference signal block 208, which may be (as an example) the fourth block in the uplink subframe 200, may include a demodulation reference signal. In the example embodiment shown in FIG 2A, the dedicated demodulation reference signal block 208 is the fourth block. However, the demodulation reference signal may be included in blocks other than the fourth block, according to example embodiments (e.g., may be located in any of the blocks in the subframe 200).

In the example embodiment shown in FIG. 2A, the uplink subframe 200 may also include a variable block 218, which may be included in the ninth block; the variable block 218 may be included in blocks other than the ninth block, according to example embodiments (e.g., the variable block 218 may be at any location or block(s) in a subframe). The variable block 218 may be considered variable because the signal included in the variable block 218 may vary between two or more different signals. For example, variable block 218 may include one of a demodulation reference signal, a sounding reference signal, or a data signal. The wireless node 106 may determine, such as based on a signal or instruction received from the infrastructure node 104, a signal to be included in the variable block 218, and the signal may include the sounding reference signal, the demodulation reference signal, or the data signal, according to an example embodiment. The uplink subframe 200 may include a signal, field or bit indicating whether the variable block 218 includes a sounding reference signal, a demodulation reference signal, or a data signal. The signal including the bit or field (e.g., indicating the signal present in the variable block 218) may be included in one of the data blocks 202-206, 210-216, or may be included in the variable block 218, for example.

FIG. 2B shows a block diagram of the uplink subframe 200 in which the variable block 218 includes a sounding reference signal, according to an example embodiment. In this example, the wireless node 106 may have determined to transmit the uplink subframe 200 with one demodulation reference signal, such as in the dedicated demodulation reference signal block 208, one sounding reference signal in the variable block 218, and data signals in the other seven blocks 202-206, 210-216. The wireless node 106 may have determined to transmit these signals based on a signal or instruction that the wireless node 106 received from the infrastructure node 104, according to an example embodiment. Thus, in such example, a sounding reference signal would be provided within the variable block 218.

FIG. 2C shows a block diagram of the uplink subframe 200 in which the variable block 218 includes a demodulation reference signal, according to an example embodiment. In this example, the wireless node 106 may have determined to transmit the uplink subframe 200 with two demodulation reference signals, such as in the dedicated demodulation reference signal block 208 and in the variable block 218, and data signals in the other seven blocks 202-206, 210-216. The wireless node 106 may have determined to transmit these signals based on a signal or instruction that the wireless node 106 received from the infrastructure node 104, according to an example embodiment. Thus, in such example, a demodulation reference signal would be provided within the variable block 218 (which would result in demodulation reference signals being provided in two blocks within the subframe 200).

FIG. 2D shows a block diagram of the uplink subframe 200 in which the variable block 218 includes data, and the fifth block 210 includes the demodulation reference signal, according to an example embodiment. In this example, the fourth block, labeled 208, may include data instead of a demodulation reference signal. In this example, the wireless node 106 may have determined to transmit the subframe with one demodulation reference signal, such as in the fifth block 210, no sounding reference signal, and data in the remaining eight blocks, including blocks 202-208, blocks 212-216, and the variable block 218. Thus, in such example, data would be provided within the variable block 218.

FIG. 2E is a block diagram of the uplink subframe 200 in which the second and eighth blocks 204, 216 include demodulation reference signals. In this example, the fourth and ninth blocks, labeled 208, 218, may include data instead of reference signals, and the remaining blocks 202, 206, 210-214 may also include data signals.

It should be understood that the variable block 218 may be provided in any location or within any of the blocks of a subframe 200. Likewise, the block that may be used or dedicated to provide a demodulation reference signal (e.g., block 210) may be provided in any location. The locations of the various blocks are merely examples, and the disclosure is not limited thereto. For example, a standard or specification may indicate a particular location that should be used for the variable block 218. The variable block 218 may then be provided in this particular location or block within a subframe, and the contents of (or type of signals within) the variable block 218 may change or vary, e.g., being either data, a demodulation reference signal, or a sounding reference signal. In an example embodiment, the type of signals that should be provided within variable block 218 may be requested or specified (e.g., via an instruction) by an infrastructure node 104 to which the subframe 200 is transmitted.

According to another example embodiment (which is not shown), the uplink subframe 200 may include a number N of blocks. In this example, one of the N blocks may include a dedicated demodulation reference signal block 208 and may be dedicated to (or allocated specifically for) including a demodulation reference signal. Also, one of the blocks may include a variable block 218 which may include a data signal, a demodulation reference signal, or a sounding reference signal, and the remainder, N−2 blocks, may include data signals, for example. In this example, the wireless node may determine to include either a) two demodulation signals in two of the blocks (such as in the dedicated demodulation reference signal block 208 and in the variable block 218), and data signals in the N−2 remaining blocks; b) one demodulation signal in one of the blocks (such as in the dedicated demodulation reference signal block 208), one sounding reference signal in one of the blocks (such as in the variable block 218), and data signals in the N−2 remaining blocks; or c) one demodulation reference signal in one of the blocks (such as in the dedicated demodulation reference signal block 208), and data signals in N−1 blocks (such as in the variable block 218 and the N−2 remaining blocks).

The use of a variable block may provide a flexible and efficient technique to provide different types and numbers of reference signals to the infrastructure node. For example, a subframe having a variable block may allow the infrastructure node, for example, to designate the type of signals such as a number and type of reference signals that should be included in an uplink subframe, which may be based on (or tailored to address) the needs of the infrastructure node.

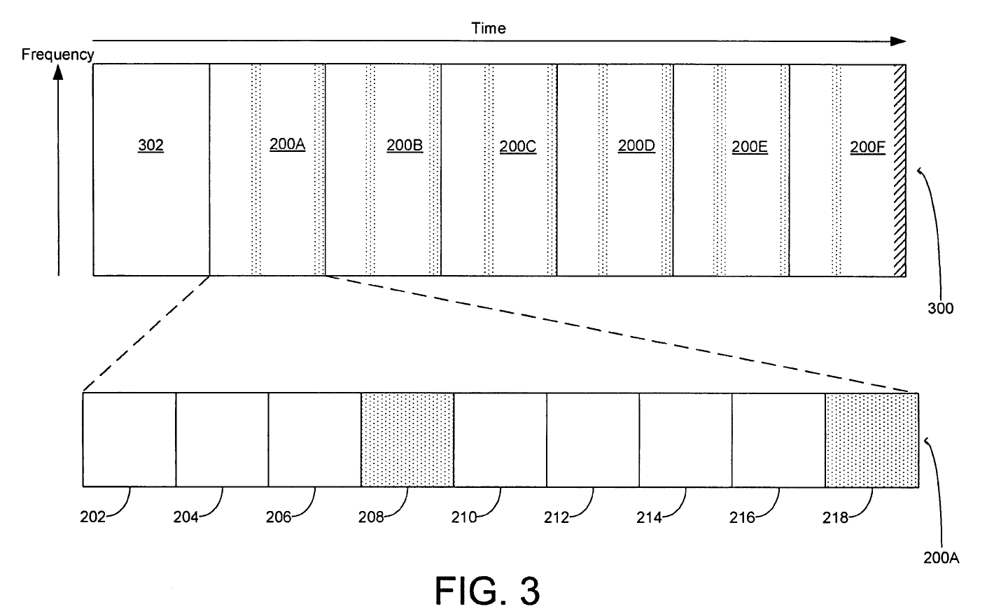

FIG. 3 is a block diagram of a frame 300 including subframes 302, 200A-F according to an example embodiment. In a time division duplexing (TDD) scheme, the subframes 302, 200A-F may be transmitted at different time slots, which time slots may be consecutive, as suggested by the arrow labeled, “Time”.

In the example shown in FIG. 3, the downlink subframe 302 may be transmitted from the infrastructure node 104 to the wireless node 106, and the uplink subframes 200A-F may be transmitted from the wireless node 106 to the infrastructure node 104. Also in this example, the dotted regions within the uplink subframes 200A-F correspond to demodulation reference signal blocks 208 and variable blocks 218 which include demodulation reference signals, the hatched region within the uplink subframe 200F corresponds to the variable block 218 which includes a sounding reference signal, and the blank regions of the uplink subframes 200A-F correspond to blocks 202-206, 210-216 which may include data signals. For example, the uplink subframe 200A may include data signals in blocks 202-206, 210-216, and may include demodulation reference signals in the dedicated demodulation reference signal block 208 and in the variable block 218.

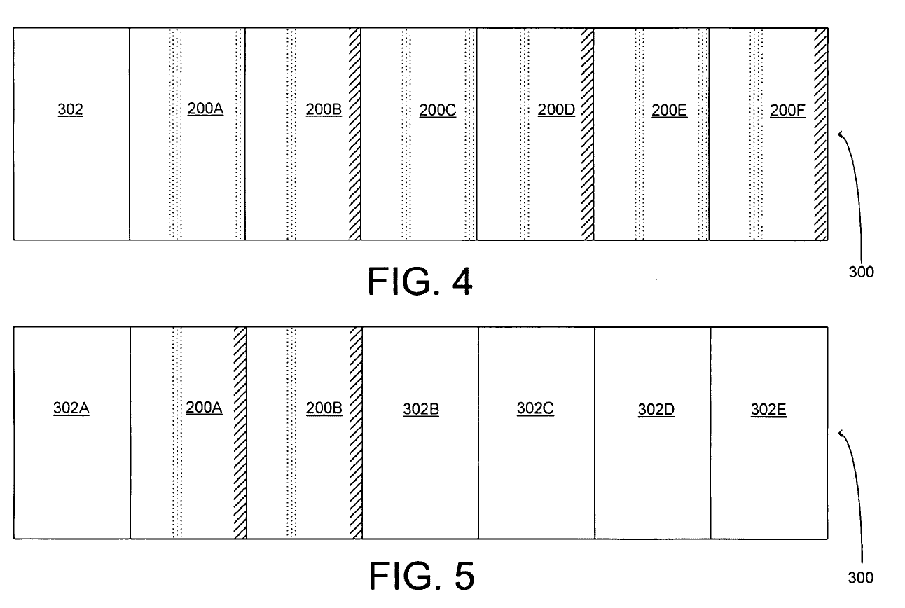

FIG. 4 is a block diagram of a frame 300 according to another example embodiment. In this example, the frame 300 includes one downlink subframe 302 and six uplink subframes 200A-F. As in FIG. 3, the dotted regions within the uplink subframes 200A-F correspond to dedicated demodulation reference signal blocks 208 and variable blocks 218 which include demodulation reference signals, the hatched regions within the uplink subframes 200B, D, E correspond to variable blocks 218 which include sounding reference signals, and the blank regions of the uplink subframes 200A-F correspond to blocks 202-206, 210-216 which may include data signals. In this example, the uplink subframes 200A-F alternate between including two demodulation reference signals, or including one demodulation reference signal and one sounding reference signal. In this example, the infrastructure node 104 which processes the uplink subframes 200B-F may benefit from the second demodulation reference signal or the sounding reference signal from the previous uplink subframe 200A-E.

The allocation of uplink subframes 200 and downlink subframes 302 may be varied according to need, such as whether more data needs to be transmitted from the wireless nodes 106, 108 up to the infrastructure node 104, or from the infrastructure node 104 down to the wireless nodes 106, 108. FIG. 5 is a block diagram of a frame 300 according to another example embodiment. In this example, the frame 300 may include five downlink subframes 302A-E and two uplink subframes 200A-B. Also in this example, each uplink subframe 200A-B may include a demodulation reference signal in one block such as the dedicated demodulation reference signal block 208, a sounding reference signal in one block such as the variable block 218, and data signals in the remaining blocks such as blocks 202-206, 210-216. In other examples, there may be other combinations of uplink subframes 200 and downlink subframes 302, with the uplink subframes 200 having other combinations of signals within their variable blocks 218.

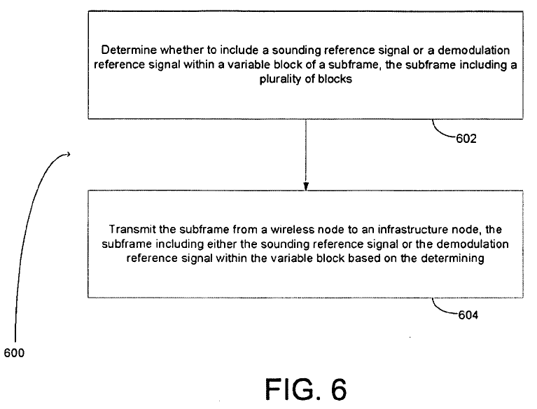

FIG. 6 is a flowchart showing a method 600 according to an example embodiment. In this example method 600, a determination may be made whether to include a sounding reference signal or a demodulation reference signal within a variable block 218 of a subframe 200, the subframe 200 including a plurality of blocks 202-218 (602). In an example embodiment, each block may include a plurality of subcarriers. Also according to this example method 600, the subframe 200 may be transmitted from a wireless node 106 to an infrastructure node 104, the subframe 200 including either the sounding reference signal or the demodulation reference signal within the variable block 218 based on the determining (604).

According to one example, the subframe 200 may also include a demodulation reference signal within a dedicated demodulation reference signal block 208. The subframe 200 may also include data within one or more additional blocks of the subframe 200. The subframe 200 may include a plurality, such as twelve, subcarriers, and each subcarrier may have an equal bandwidths, such as approximately fifteen kilohertz each.

The determining may be performed based on an instruction received from the infrastructure node 104, according to an example embodiment.

In an example embodiment, the subframe 200 may be included in a time division duplexed frame 300. The subframe 200 may have a duration or period of approximately 0.675 milliseconds.

In another example embodiment, transmitting the subframe 200 may include transmitting a plurality of subframes 200, the plurality of subframes 200 including either the sounding reference signal or the demodulation reference signal in an alternating sequence.

In yet another example embodiment, transmitting the subframe 200 may include transmitting a signal indicating whether the subframe 200 includes the sounding reference signal or the demodulation reference signal within the variable block 218.

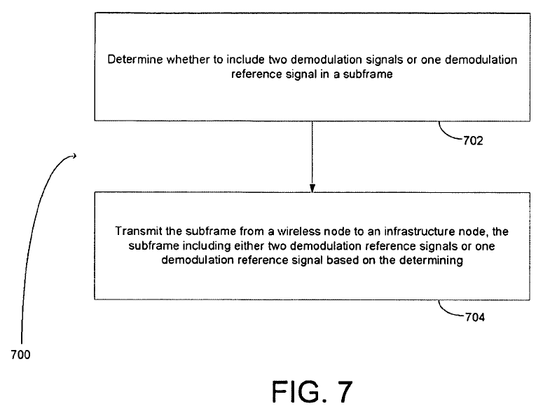

FIG. 7 is a flowchart showing a method 700 according to another example embodiment. According to this example, the method 700 may include determining whether to include two demodulation reference signals or one demodulation reference signal in a subframe 200 (702). The method 700 may further include transmitting the subframe 200 from a wireless node 106 to an infrastructure node 104, the subframe 200 including either two demodulation reference signals or one demodulation reference signal based on the determining (704). If the subframe 200 includes one demodulation reference signal, the subframe 200 may also include a sounding reference signal.

According to an example embodiment, the subframe 200 may include a number N of blocks. Based on the determining, the subframe 200 may include either a) the two demodulation reference signals in two of the blocks and data signals in N−2 of the blocks; b) the one demodulation reference in one of the blocks and a sounding reference signal in one of the blocks and data signals in N−2 of the blocks; or c) the one demodulation reference signal in one of the blocks and data signals in N−2 of the blocks.

According to an example embodiment, the subframe 200 may include nine blocks. Based on the determining, the subframe 200 may include either a) the two demodulation reference signals in two of the blocks and data signals in seven of the blocks; b) the one demodulation reference in one of the blocks and a sounding reference signal in one of the blocks and data signals in seven of the blocks; or c) the one demodulation reference signal in one of the blocks and data signals in seven of the blocks.

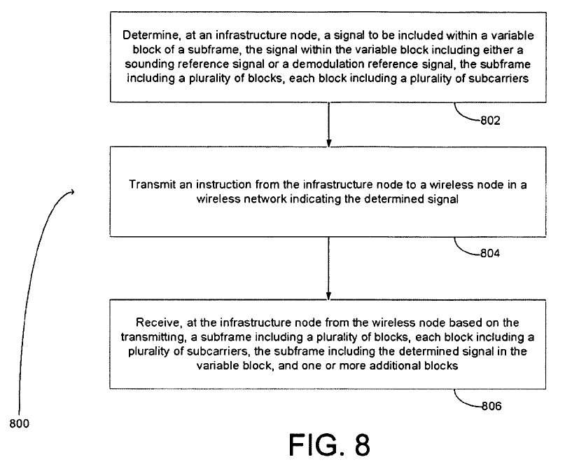

FIG. 8 is a flowchart showing a method 800 according to another example embodiment. According to this example, the method 800 includes determining, at an infrastructure node 104, a signal to be included within a variable block 218 of a subframe 200, the signal within the variable block 218 including either a sounding reference signal or a demodulation reference signal, the subframe 200 including a plurality of blocks, each block including a plurality of subcarriers (802). The method 800 may also include transmitting an instruction from the infrastructure node 104 to a wireless node 106 in a wireless network 102 indicating the determined signal (804). The method 800 may also include receiving, at the infrastructure node 104 from the wireless node 106 based on the transmitting, a subframe 200 including a plurality of blocks, each block including a plurality of subcarriers, the subframe 200 including the determined signal in the variable block 218 and one or more additional blocks (806). The subframe 200 may also include a demodulation reference signal within a dedicated demodulation reference signal block 208 and data signals within one or more blocks of the subframe 200.

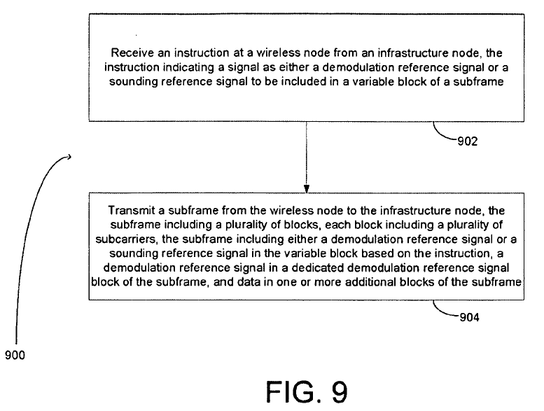

FIG. 9 is a flowchart showing a method 900 according to another example embodiment. According to this example, the method 900 may include receiving an instruction at a wireless node 106 from an infrastructure node 104, the instruction indicating a signal as either a demodulation reference signal or a sounding reference signal to be included in a variable block 218 of a subframe 200 (902). The method 900 may also include transmitting the subframe 200 from the wireless node 106 to the infrastructure node 104, the subframe 200 including a plurality of blocks, each block including a plurality of subcarriers, the subframe 200 including either a demodulation reference signal or a sounding reference signal in the variable block 218 based on the instruction, a demodulation reference signal in a demodulation reference signal block 208 of the subframe 200, and data in one or more additional blocks of the subframe 200 (902).

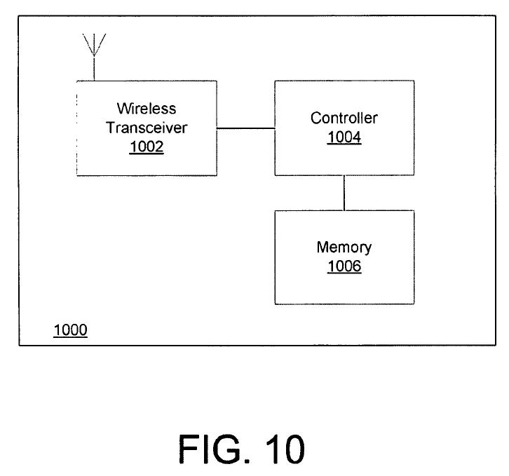

FIG. 10 is a block diagram illustrating an apparatus 1000 that may be provided in a node, such as a wireless node 106 or infrastructure node 104 according to an example embodiment. According to an example embodiment, the apparatus 1000 may be configured to determine whether to include a sounding reference signal or a demodulation reference signal within a variable block 218 of a subframe 200, the subframe 200 including a plurality of blocks, each block including a plurality of subcarriers. The apparatus 1000 may also be configured to transmit the subframe 200 from a wireless node 106 to an infrastructure node 104, the subframe 200 including either the sounding reference signal or the demodulation reference signal within the variable block 218 based on the determination.

The apparatus may include a wireless transceiver 1002, a controller 1004, and a memory 1006. The controller 1004 may be configured to determine whether to include a sounding reference signal or a demodulation reference signal within a variable block 218 of a subframe 200, the subframe 200 including a plurality of blocks, each block including a plurality of carriers. The transceiver 1002 may be configured to transmit the subframe 200 to an infrastructure node 104, the subframe 200 including either the sounding reference signal or the demodulation reference signal within the variable block 218 based on the determination. The memory 1006 may be configured to store past operations or determinations, and may be accessible to the controller 1004.

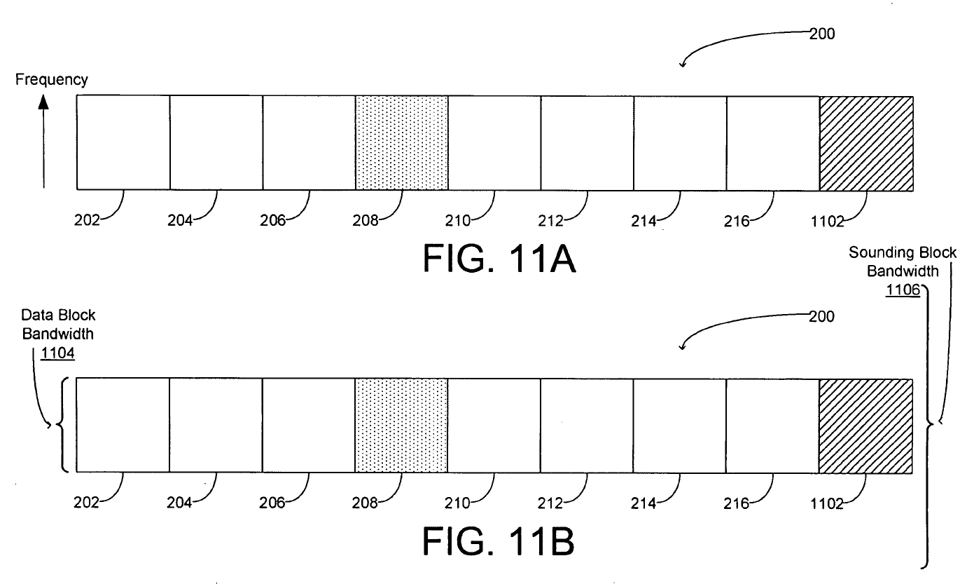

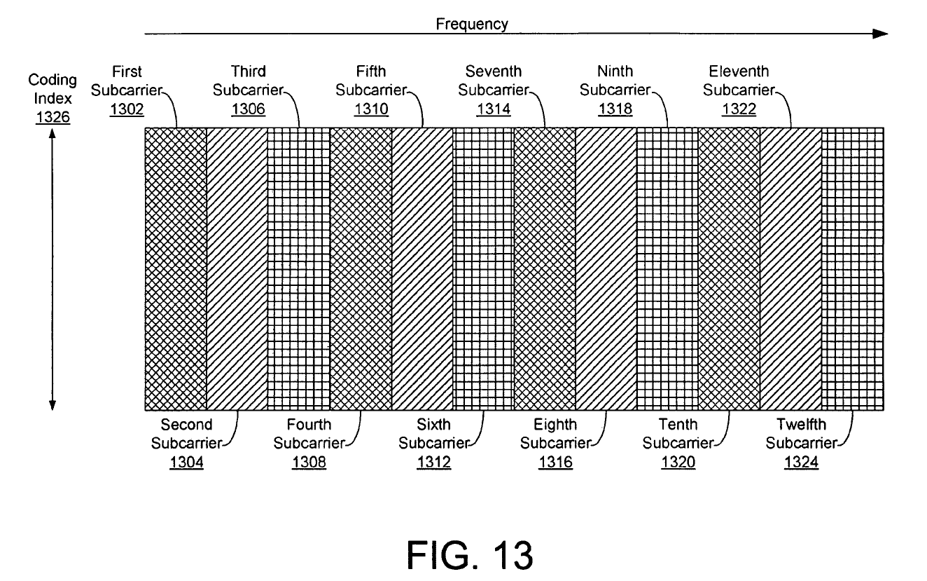

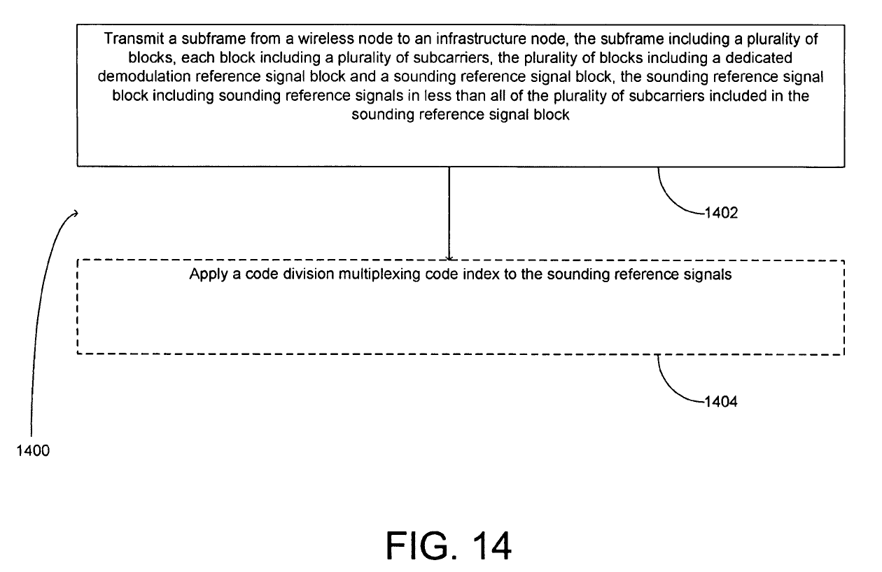

FIG. 11A is a block diagram showing the uplink subframe 200 according to an example embodiment in which the uplink subframe 200 includes one dedicated demodulation reference signal block 208 and one sounding reference signal block 11 02. The uplink subframe 200 may include a plurality of blocks 202-216, 1102, such as nine in the example shown in FIG. 11A. Each block 202-216, 1102 may include a plurality of subcarriers, which are discussed in further detail with reference to FIG. 13. According to an example embodiment, the uplink subframe 200 may have a duration of 0.675 milliseconds. The blocks 202-206, 210-216 other than the dedicated demodulation reference signal block 208 and sounding reference signal block 1102 may include data signals, according to an example embodiment. According to an example embodiment, the uplink subframe 200 shown in FIG. 11A may be transmitted from a wireless node 106 to an infrastructure node 104, and the infrastructure node 104 may receive the uplink subframe 200 from the wireless node 106. In this example, the infrastructure node 104 may use information included in the sounding reference signal block 1102 to demodulate data signals included in the plurality of blocks 202-206, 210-216.

While the example embodiment shown in FIG. 11A shows the subframe 200 with nine blocks 202-216, 1102, and the demodulation reference signal block 208 in the fourth block and the sounding reference signal block 1102 in the ninth block, subframes 200 with other numbers of blocks may be sent, and the demodulation reference signal block 208 and sounding reference signal block 1102 may be sent in other positions within the subframe 200.

FIG. 11B is a block diagram showing the uplink subframe 200 according to an example embodiment in which the sounding reference signal block 1102 has a greater bandwidth than the other blocks 202-216 included in the plurality of blocks 202-216, 1102. In this example, a data block bandwidth 1104 may be substantially equal for all of the blocks 202-216 other than the sounding reference signal block 1102. Also in this example, a sounding block bandwidth 1106 may be greater than the data block bandwidth 1104. The difference between the sounding block bandwidth 1106 and the data block bandwidth 1104 may be a function of a repetition factor. The repetition factor may determine how many of the plurality of subcarriers included in the sounding reference signal 1102 are or carry sounding reference signals, and is discussed in further detail with reference to FIG. 13.

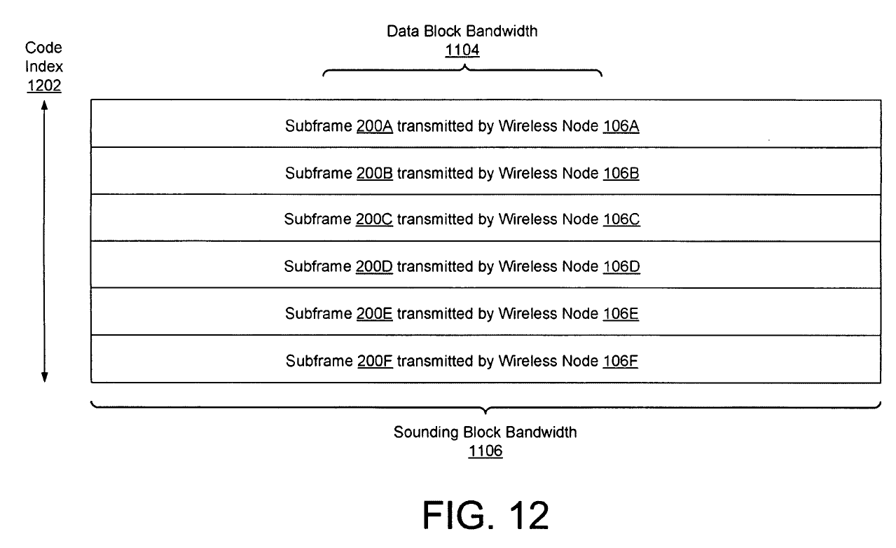

FIG. 12 is a block diagram showing a plurality of subframes 200A-F each transmitted by a different wireless node 106A-F, according to an example embodiment. In this example, the sounding block bandwidth 1106 of each of the sounding reference signal blocks 1102 of each of the subframes 200A-F may be greater than the data block bandwidth 1102 of the other blocks 202-216 included in the subframes 200A-F.

In an example embodiment, each of the subframes 200A-F may be associated with a code index 1202. The code index 1202 may be used for code division multiplexing, according to an example embodiment. For example, the wireless nodes 106A-F may each apply their distinct code index 1202 to the sounding reference signal included in the sounding reference signal blocks 1102 of their respective subframes 200A-F, or may each apply their distinct code index 1202 to the signals in all the blocks 202-216, 1102 of their respective subframes 200A-F. The infrastructure node 104 may apply the code index 1202 to code division demultiplex information or signals included in either the sounding reference signal block 1102 or all of the blocks 202-216, 1102 in each received subframe 200A-F, according to an example embodiment.

According to an example embodiment, coding of the subframes 200A-F may be performed using a cyclic shift of the initial sequence. For example, a reference signal may be generated from a sequence, such as a CAZAC sequence. Cyclic shifting may generate another sequence, which may be used by another wireless node 106A-F in transmitting its respective subframe 200A-F. The generated sequences may be orthogonal to each other, according to an example embodiment.

FIG. 13 is a block diagram showing a plurality of subcarriers 1302-1324 along which a plurality of wireless nodes 106 (not shown in FIG. 13) using a repetition factor greater than one may transmit sounding reference signals, according to an example embodiment. In an example embodiment, the sounding reference signal block 1102 may include reference signals in less than all of the plurality of subcarriers 1302-1324.

The sounding reference signals may be included in subcarriers which are ordered periodically in the sounding reference signal block 1102. The sounding reference signals may be included in every Nth subcarrier 1302-1324, where N is the repetition factor, according to an example embodiment. For example, if the wireless node 106 uses a repetition factor of two, the sounding reference signals may be included in every other subcarrier 1302-1324 which is included in the sounding reference signal block 1102; if the wireless node 106 uses a repetition factor of three, the sounding reference signals may be included in every third subcarrier 1302-1324 which is included in the sounding reference signal block 1102; if the wireless node 106 uses a repetition factor of four, the sounding reference signals may be included in every fourth subcarrier 1302-1324 which is included in the sounding reference signal block 1102.

If a wireless node 106 uses a repetition factor greater than one, then the sounding block bandwidth 1106 of the wireless node 106 may overlap with the sounding block bandwidth 1106 of one or more other nodes 106. In the example embodiment shown in FIG. 13, three wireless nodes 106 using repetition factors of three have overlapping sounding block bandwidths 1106. In this example, a first node 106 may transmit sounding reference signals along the first subcarrier 1302, the fourth subcarrier 1308, the seventh subcarrier 1314, and the tenth subcarrier 1320; the second node 106 may transmit sounding reference signals along the second subcarrier 1304, the fifth subcarrier 1310, the eighth subcarrier 1316, and the eleventh subcarrier 1322; and the third wireless node 106 may transmit sounding reference signals along the third subcarrier 1306, the sixth subcarrier 1312, the ninth subcarrier 1318, and the twelfth subcarrier 1324. With the overlapping bandwidths and the repetition factors, the sounding reference signal blocks 1102 may have sounding block bandwidths 1106 greater than the data block bandwidths 1104.

The subcarriers 1302-1326 along which a wireless node 106 transmits sounding reference signals may hop in frequency, according to an example embodiment. In this example, the subcarriers along which the wireless node 106 transmits sounding reference signals may change from one subframe 200 to the next in a pseudorandom manner. Or, the wireless node 106 may transmit sounding reference signals along subcarriers which were outside the sounding block bandwidth 1106 of a preceding subframe 200, according to an example embodiment.

The sounding reference signals transmitted along the subcarriers 1302-1324 may have been code division multiplexed by the wireless nodes 106 according to a coding index 1326, according to an example embodiment. Code division multiplexing may reduce interference between the subcarriers 1302-1324, according to an example embodiment. The infrastructure node 104 may code division demultiplex the sounding reference signals using the same coding index 1326, according to an example embodiment. The infrastructure node 104 may use the sounding reference signals for demodulation purposes; however, the wireless node 106 may or may not be aware that the infrastructure node 104 is using the sounding reference signals for demodulation signals, according to an example embodiment.

FIG. 14 is a flowchart showing a method 1400 according to an example embodiment. According to this example, the method 400 may include transmitting a subframe 200 from a wireless node 106 to an infrastructure node 104, the subframe 200 including a plurality of blocks 202-216, 1102, each block 202-216, 1102 including a plurality of subcarriers 1302-1324, the plurality of blocks 202-216, 1102 including a dedicated demodulation reference signal block 208 and a sounding reference signal block 1102, the sounding reference signal block 1102 including sounding reference signals in less than all of the plurality of subcarriers 1302-1324 included in the sounding reference signal block 1102 (1402).

According to an example embodiment, each of the plurality of blocks 202-206, 210-216 other than the dedicated demodulation reference signal block 208 and the sounding reference signal block 1102 may include data signals.

According to another example embodiment, the sounding reference signal block 1102 may have a greater bandwidth than the other blocks 202-216 included in the plurality of blocks 202-216, 1102.

According to another example embodiment, the sounding reference signals may be included in subcarriers 1302-1324 which are ordered periodically within the sounding reference signal block 1102.

According to another example embodiment, the sounding reference signals may be included in every other subcarrier 1302-1324 which is included in the sounding reference signal block 1102.

According to another example embodiment, the sounding reference signals may be included in every third subcarrier 1302-1324 which is included in the sounding reference signal block 1102.

According to another example embodiment, the sounding reference signals may be included in every fourth subcarrier 1302-1324 which is included in the sounding reference signal block 1102.

According to another example embodiment, each block may include twelve subcarriers 1302-1324; the sounding reference signal block 1102 may include twelve subcarriers divided by the repetition factor.

According to another example embodiment, method 1400 may further comprise applying a code division multiplexing code index 1202, 1326 to the sounding reference signals (1404).

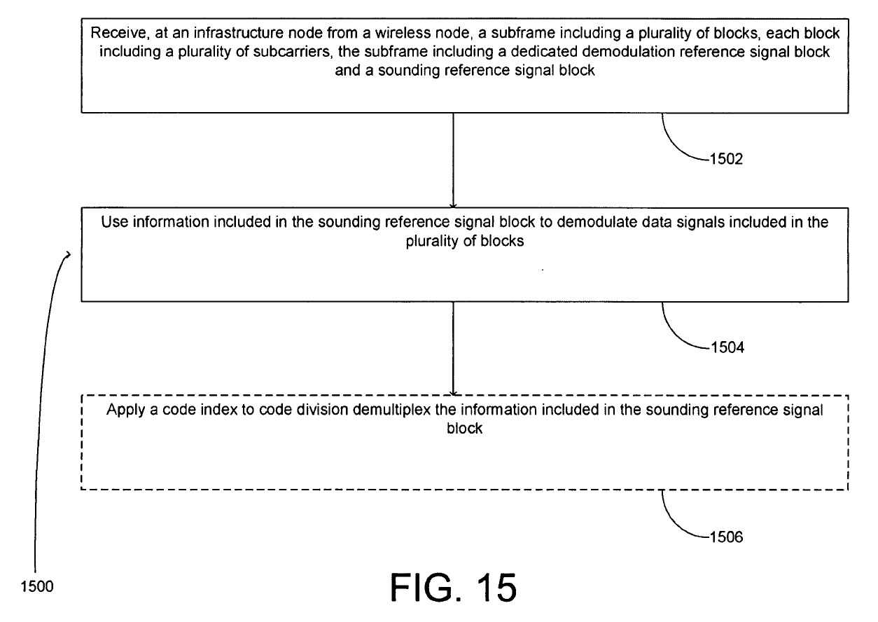

FIG. 15 is a flowchart showing a method 1500 according to another example embodiment. According to this example, the method 1500 may comprise receiving, at an infrastructure node 104 from a wireless node 106, a subframe 200 including a plurality of blocks 202-216, 1102, each block 202-216, 1102 including a plurality of subcarriers 1302-1324, the subframe 200 including a dedicated demodulation reference signal block 208 and a sounding reference signal block 1102 (1502). The method 1500 may further comprise using information included in the sounding reference signal block 1102 to demodulate data signals included in the plurality of blocks 202-206, 210-216 (1504).

According to an example embodiment, the receiving may include receiving a plurality of subframes 200, each of the subframes 200 including a plurality of blocks 202-216, 1102, each block 202-216, 1102 including a plurality of subcarriers 1302-1324, each subcarrier 1302-1324 including the dedicated demodulation reference signal block 208 and the sounding reference signal block 1102, the sounding reference signal blocks 1102 having overlapping bandwidths.

According to another example embodiment the sounding reference signal block 1102 may have a greater bandwidth than the other blocks 202-216 included in the plurality of blocks 202-216, 1102.

According to another example embodiment, the method 1500 may further comprise applying a code index 1202, 1326 to code division demultiplex the information included in the sounding reference signal block 1102 (1506).

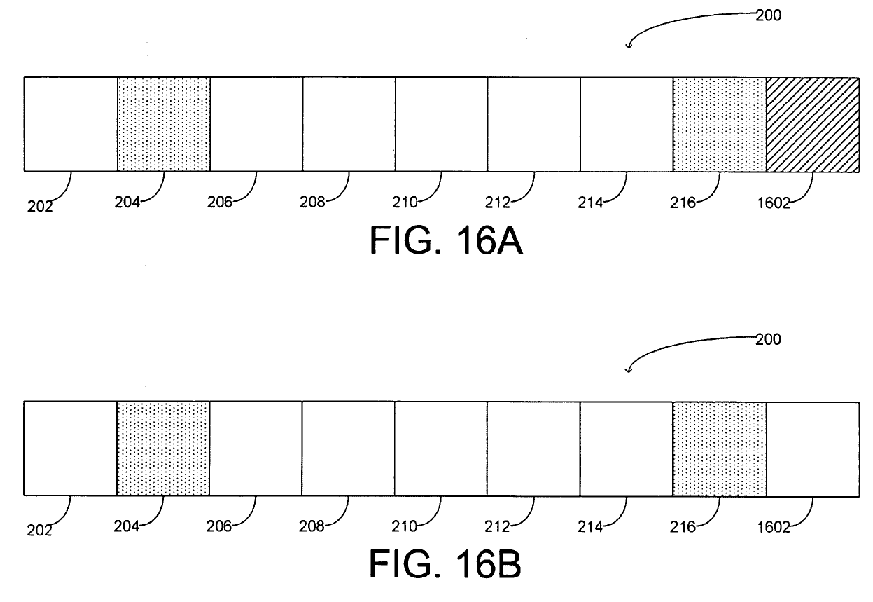

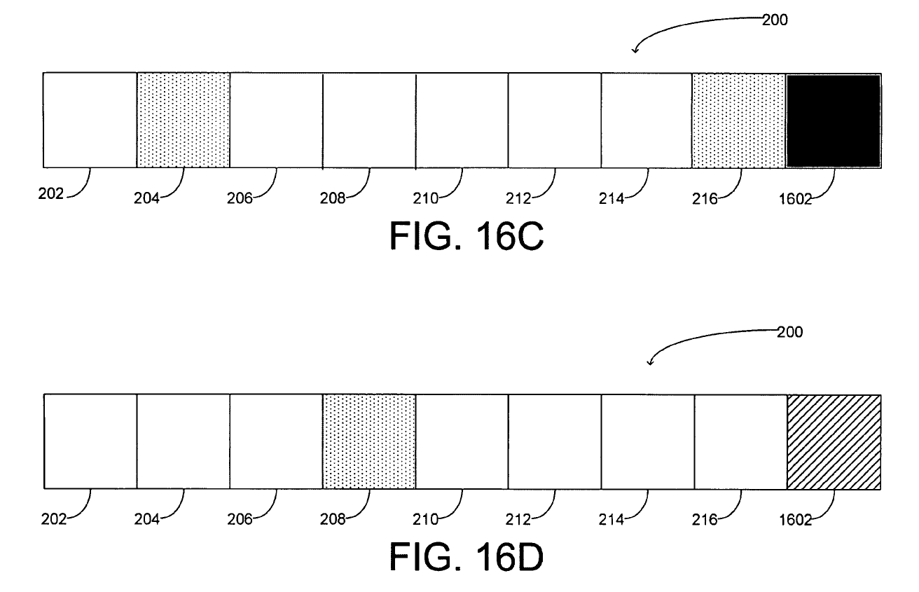

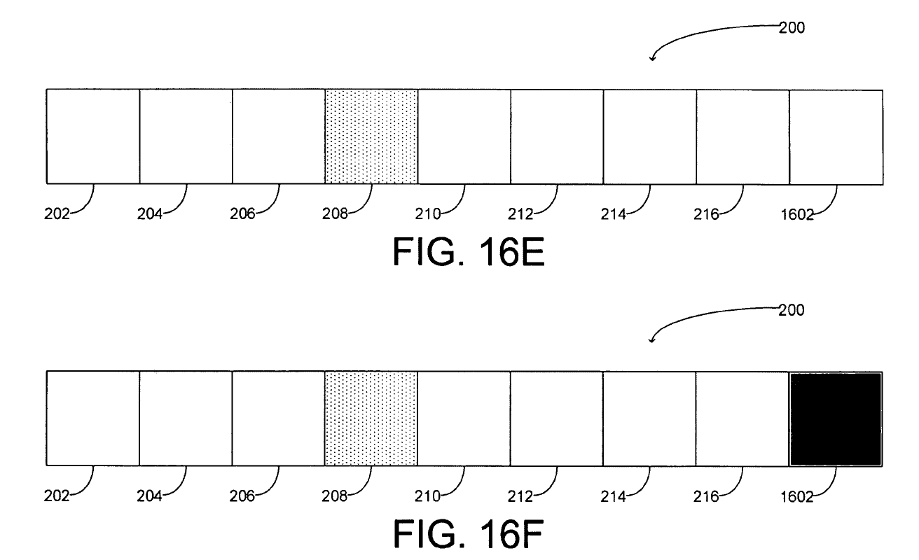

FIGS. 16A-C are block diagrams showing the uplink subframe 200 according to an example embodiment in which the uplink subframe 200 includes two dedicated demodulation reference signal blocks 204 and 216 and a variable block 1602. The uplink subframe 200 may include a plurality of blocks 202-216, 1602, such as nine in the example shown in FIGS. 16A-C. Each block 202-216, 1602 may include a plurality of subcarriers. According to an example embodiment, the uplink subframe 200 may have a duration of 0.675 milliseconds. The blocks 202, 206-214 other than the dedicated demodulation reference signal blocks 204, 216 and the variable block 1602 may include data signals, according to an example embodiment. According to an example embodiment, the uplink subframe 200 shown in FIGS. 16A-C may be transmitted from a wireless node 106 to an infrastructure node 104, and the infrastructure node 104 may receive the uplink subframe 200 from the wireless node 106. In this example, the infrastructure node 104 may use information included in the demodulation reference signal blocks 204 and 216 to demodulate data signals included in the plurality of blocks 202, 206-214.

While the example embodiments shown in FIGS. 16A-C show the subframe 200 with nine blocks 202-216, 1602, and the demodulation reference signal blocks 204, 216 and the variable block 1602 in the second, eighth, and ninth blocks, respectively, subframes 200 with other numbers of blocks may be sent, and the demodulation reference signal blocks 204 and 216 and sounding reference signal block 1102 may be sent in other positions within the subframe 200.

The variable block 1602 may include a sounding reference signal(s), data reference signal(s), or no signal, according to an example embodiment. In the latter case of no signal, the infrastructure node 106 may not transmit during the variable block's 1602 time slot, and the variable block 1602 may serve as a placeholder to wait for the next subframe 200. The wireless node 106 may determine whether to include the sounding reference signal(s) in the variable block 1602 based on an instruction received from the infrastructure node 104, according to an example embodiment. The instruction from the infrastructure node 104 may also indicate whether the wireless node 106 should transmit a subframe 200 which includes demodulation reference signals in either one or two blocks 202-216 of the subframe 200, according to an example embodiment. Example subframes 200 which include demodulation reference signals in one block 208 are shown in FIGS. 16D-F.

According to an example embodiment, the infrastructure node 104 may determine a frequency region along which the wireless node 106 should transmit the subframe 200. For example, a high-speed frequency region may be allocated to wireless nodes 106, 108 which are traveling at high speeds, such as in an automobile or a train. The infrastructure node 104 may determine a frequency region, such as the high-speed frequency region, within which the wireless node 106 should transmit a subframe 200 to the infrastructure node 106. This determination may be made based on a determined speed of the wireless node, for example. The infrastructure node 104 may transmit an instruction to the wireless node 106 indicating the determined frequency region, and the wireless node 106 may receive the instruction to transmit the subframe from the wireless node 106 to the infrastructure node 104 along the frequency region.

The wireless node 106 may determine how many blocks 202-216 should include demodulation reference signals, and whether the variable block 1602 should include a sounding reference signal, based on the indicated frequency region included in the instruction. For example, based on the instruction to transmit the subframe 200 along the high-speed frequency region, the wireless node 106 may transmit a subframe 200 to the infrastructure node 104 which includes demodulation reference signals in two blocks 204, 216, and which does not include a sounding reference signal in the variable block 1602. The variable block 1602 may include a data signal(s) or be empty, according to example embodiments.

According to another example, the infrastructure node 104 may transmit a signal or instruction to the wireless node 106 indicating whether to include demodulation reference signals in one or two blocks 202-216 of the subframe 200, whether or not to include a sounding reference signal(s) in the variable block 1602, and if the variable block 1602 is not to include the sounding reference signal(s) whether the variable block 1602 should include a data signal(s) or be empty. In this example, the wireless node 106 may transmit the subframe 200 to the infrastructure node 104 in accordance with the instruction.

FIG. 16A is a block diagram showing the uplink subframe 200 according to an example embodiment in which the variable block 1602 includes a sounding reference signal(s). In this example, the variable block 1602 may have a greater bandwidth than the other blocks 202-216 included in the plurality of blocks 202-216, 1602, as discussed with reference to FIGS. 11B, 12, and 13. In this example, a data block bandwidth 1104 (not shown in FIG. 16A) may be substantially equal for all of the blocks 202-216 other than the variable block 1602. Also in this example, a bandwidth of the variable block 1602 may be greater than the data block bandwidth 1104. The difference between the bandwidth of the variable block 1602 and the data block bandwidth 1104 may be a function of the repetition factor. The repetition factor may determine how many of the plurality of subcarriers included in the variable block 1602 carry sounding reference signals, as discussed with reference to FIG. 13.

FIG. 16B is a block diagram showing the uplink subframe 200 according to an example embodiment in which the uplink subframe 200 includes two dedicated demodulation reference signal blocks 204, 216, and the variable block 1602 includes a data signal(s). The uplink subframe 200 may include a plurality of blocks 202-216, 1602, such as nine, in the example shown in FIG. 16B. Each block 202-216, 1602 may include a plurality of subcarriers. According to an example embodiment, the uplink subframe 200 may have a duration of 0.675 milliseconds. The blocks 202, 206-214, 1602 other than the dedicated demodulation reference signal blocks 204 and 216 may include data signals, according to an example embodiment. According to an example embodiment, the uplink subframe 200 shown in FIG. 16B may be transmitted from a wireless node 106 to an infrastructure node 104, and the infrastructure node 104 may receive the uplink subframe 200 from the wireless node 106. In this example, the infrastructure node 104 may use information included in the demodulation reference signal blocks 204 and 216 to demodulate data signals included in the plurality of blocks 202, 206-214, 1602.

While the example embodiment shown in FIG. 16B shows the subframe 200 with nine blocks 202-216, 1602, and the demodulation reference signal blocks 204, 216 in the second and eighth blocks, subframes 200 with other numbers of blocks may be sent, and the demodulation reference signal blocks 204, 216 may be sent in other positions within the subframe 200.

FIG. 16C is a block diagram showing the uplink subframe 200 according to an example embodiment in which the uplink subframe 200 includes two dedicated demodulation reference signal blocks 204, 216, and the variable block 1602 is empty, or does not include a signal. The uplink subframe 200 may include a plurality of blocks 202-216, 1602, such as nine in the example shown in FIG. 16C. Each block 202-216, 1602 may include a plurality of subcarriers. The variable block 1602 may be considered empty in this example. According to an example embodiment, the uplink subframe 200 may have a duration of 0.675 milliseconds. The blocks 202, 206-214, other than the dedicated demodulation reference signal blocks 204, 216 and the variable block 1602 may include data signals, according to an example embodiment. According to an example embodiment, the uplink subframe 200 shown in FIG. 16C may be transmitted from a wireless node 106 to an infrastructure node 104, and the infrastructure node 104 may receive the uplink subframe 200 from the wireless node 106. In this example, the infrastructure node 104 may use information included in the demodulation reference signal blocks 204 and 216 to demodulate data signals included in the plurality of blocks 202, 206-214.

FIGS. 16D-F are block diagrams showing the uplink subframe 200 according to an example embodiment in which the uplink subframe 200 includes one dedicated demodulation reference signal block 208 and a variable block 1602. The wireless node 106 may transmit the subframe with a demodulation reference signal(s) included in one block 208 based on an instruction from the infrastructure node 104, as discussed above. The wireless node 106 may also determine whether to include a sounding reference signal(s) a data signal(s) or no signal in the variable block 1602 based on an instruction from the infrastructure node 104, according to an example embodiment

FIG. 16D is a block diagram showing the uplink subframe according to an example embodiment in which the uplink subframe includes one dedicated demodulation reference signal block 208 and the variable block 1602 includes a sounding reference signal. In this example, the variable block 1602 may have a greater bandwidth than the other blocks 202-216 included in the plurality of blocks 202-216, 1602, as discussed with reference to FIGS. 11B, 12, and 13. In this example, a data block bandwidth 1104 (not shown in FIG. 16D) may be substantially equal for all of the blocks 202-216 other than the variable block 1602. Also in this example, a bandwidth of the variable block 1602 may be greater than the data block bandwidth 1104. The difference between the bandwidth of the variable block 1602 and the data block bandwidth 1104 may be a function of the repetition factor. The repetition factor may determine how many of the plurality of subcarriers included in the variable block 1602 carry sounding reference signals, as discussed with reference to FIG. 13.

FIG. 16E is a block diagram showing the uplink subframe 200 according to an example embodiment in which the uplink subframe 200 includes one dedicated demodulation reference signal block 208, and the variable block 1602 includes a data signal(s). The uplink subframe 200 may include a plurality of blocks 202-216, 1602, such as nine, in the example shown in FIG. 16E. Each block 202-216, 1602 may include a plurality of subcarriers. According to an example embodiment, the uplink subframe 200 may have a duration of 0.675 milliseconds. The blocks 202-206, 210-216, 1602 other than the dedicated demodulation reference signal block 208 may include data signals, according to an example embodiment. According to an example embodiment, the uplink subframe 200 shown in FIG. 16E may be transmitted from a wireless node 106 to an infrastructure node 104, and the infrastructure node 104 may receive the uplink subframe 200 from the wireless node 106. In this example, the infrastructure node 104 may use information included in the demodulation reference signal block 208 to demodulate data signals included in the plurality of blocks 202-206, 210-216, 1602.

While the example embodiment shown in FIG. 16E shows the subframe 200 with nine blocks 202-216, 1602 and the demodulation reference signal block 208 in the fourth block, subframes 200 with other numbers of blocks may be sent, and the demodulation reference signal block 208 may be sent in other positions within the subframe 200.

FIG. 16F is a block diagram showing the uplink subframe 200 according to an example embodiment in which the uplink subframe 200 includes one dedicated demodulation reference signal block 208, and the variable block 1602 is empty, or does not include a signal. The uplink subframe 200 may include a plurality of blocks 202-216, 1602, such as nine in the example shown in FIG. 16F. Each block 202-216, 1602 may include a plurality of subcarriers. The variable block 1602 may be considered empty in this example. According to an example embodiment, the uplink subframe 200 may have a duration of 0.675 milliseconds. The blocks 202-206, 210-216, other than the dedicated demodulation reference signal block 208 and the variable block 1602 may include data signals, according to an example embodiment. According to an example embodiment, the uplink subframe 200 shown in FIG. 16F may be transmitted from a wireless node 106 to an infrastructure node 104, and the infrastructure node 104 may receive the uplink subframe 200 from the wireless node 106. In this example, the infrastructure node 104 may use information included in the demodulation reference signal block 208 to demodulate data signals included in the plurality of blocks 202-206, 210-216.

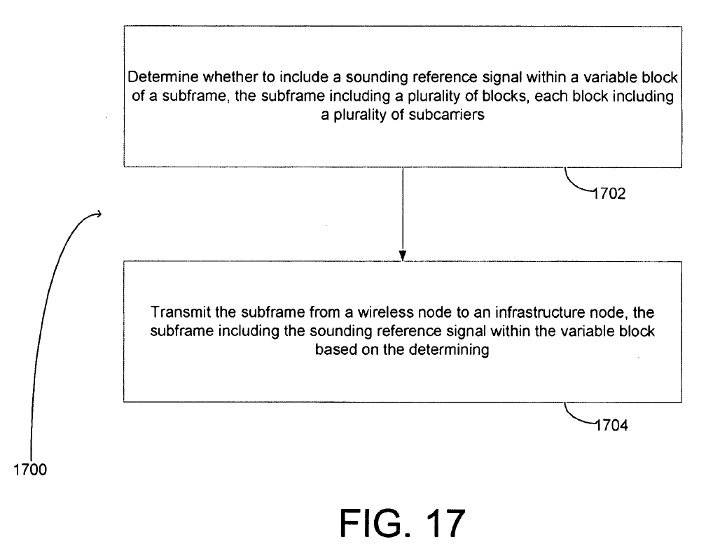

FIG. 17 is a flowchart showing a method 1700 according to an example embodiment. According to this example, the method 1700 may include determining whether to include a sounding reference signal within a variable block 1602 of a subframe 200, the subframe 200 including a plurality of blocks, each block including a plurality of subcarriers (1702). The method 1700 may further include transmitting the subframe 200 from a wireless node 106 to an infrastructure node 104, the subframe 200 including the sounding reference signal within the variable block 1602 based on the determining (1604). The subframe 200 may include either one demodulation reference signal block, or two demodulation reference signal blocks, according to an example embodiment.

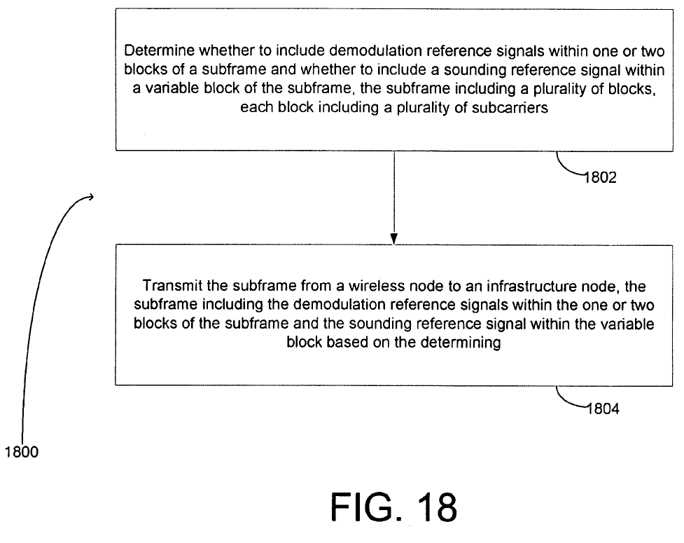

FIG. 18 is a flowchart showing a method 1800 according to another example embodiment. According to this example, the method 1800 may include determining whether to include demodulation reference signals within one or two blocks of a subframe 200 and whether to include a sounding reference signal within a variable block 1602 of the subframe 200, the subframe 200 including a plurality of blocks, each block including a plurality of subcarriers (1802). The method 1800 may further include transmitting the subframe 200 from a wireless node 106 to an infrastructure node 104, the subframe 200 including the demodulation reference signals within the one or two blocks of the subframe 200 and the sounding reference signal within the variable block 1602 based on the determining (1804).

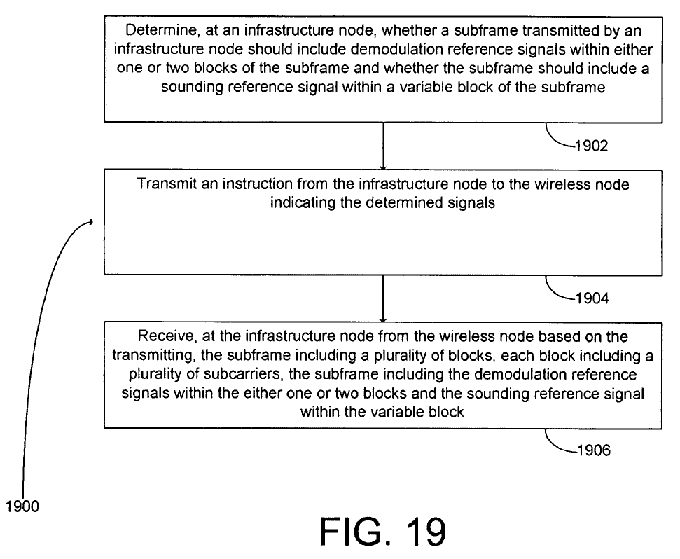

FIG. 19 is a flowchart showing a method 1900 according to another example embodiment. According to this example, the method 1900 may include determining, at an infrastructure node 104, whether a subframe 200 transmitted by an infrastructure node 106 should include demodulation reference signals within either one or two blocks of the subframe 200 and whether the subframe 200 should include a sounding reference signal within a variable block 1602 of the subframe 200 (1902). The method 1900 may further comprise transmitting an instruction from the infrastructure node 104 to the wireless node 106 indicating the determined signals (1904). The method 1900 may further include receiving, at the infrastructure node 104 from the wireless node 106 based on the transmitting, the subframe 200 including a plurality of blocks, each block including a plurality of subcarriers, the subframe 200 including the demodulation reference signals within the either one or two blocks and the sounding reference signal within the variable block 1602 (1906).

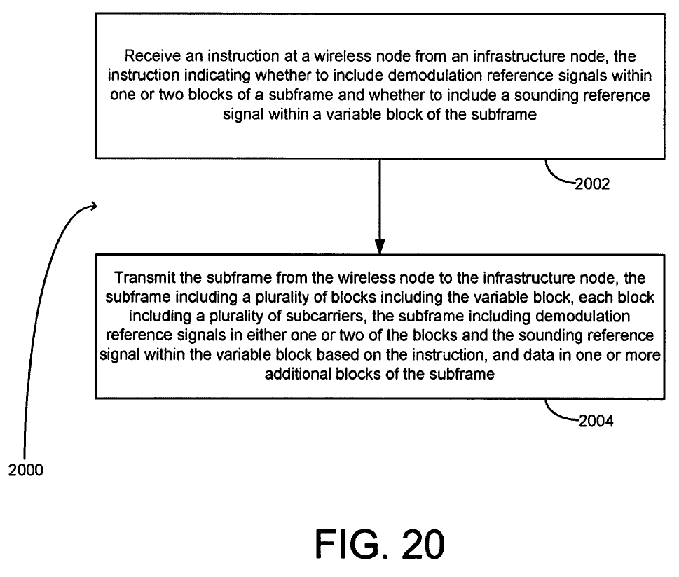

FIG. 20 is a flowchart showing a method 2000 according to another example embodiment. According to this example, the method 2000 may include receiving an instruction at a wireless node 106 from an infrastructure node 104, the instruction indicating whether to include demodulation reference signals within one or two blocks of a subframe 200 and whether to include a sounding reference signal within a variable block 1602 of the subframe 200 (2002). The method 2000 may further include transmitting the subframe 200 from the wireless node 106 to the infrastructure node 104, the subframe 200 including a plurality of blocks including the variable block 1602, each block including a plurality of subcarriers, the subframe 200 including demodulation reference signals in either one or two of the blocks and the sounding reference signal within the variable block 1602 based on the instruction, and data in one or more additional blocks of the subframe 200 (2004).

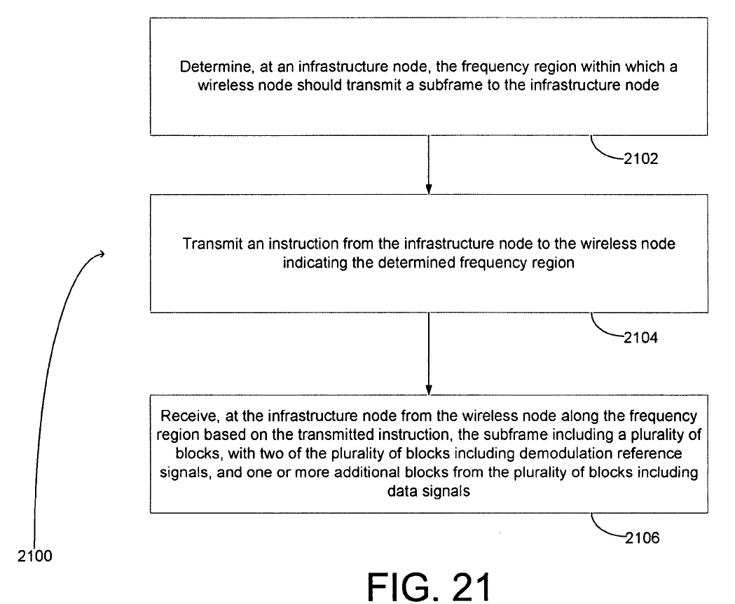

FIG. 21 is a flowchart showing a method 2100 according to another example embodiment. According to this example, the method 2100 may include determining, at an infrastructure node 104, a frequency region within which a wireless node 106 should transmit a subframe 200 to the infrastructure node 104 (2102). The method 2100 may further include transmitting an instruction from the infrastructure node 104 to the wireless node 106 indicating the determined frequency region (2104). The method 2100 may further include receiving, at the infrastructure node 104 from the wireless node 106 along the frequency region based on the transmitted instruction, the subframe 200 including a plurality of blocks, with two of the plurality of blocks including the demodulation reference signals, and one or more additional blocks from the plurality of blocks including data signals (2106).

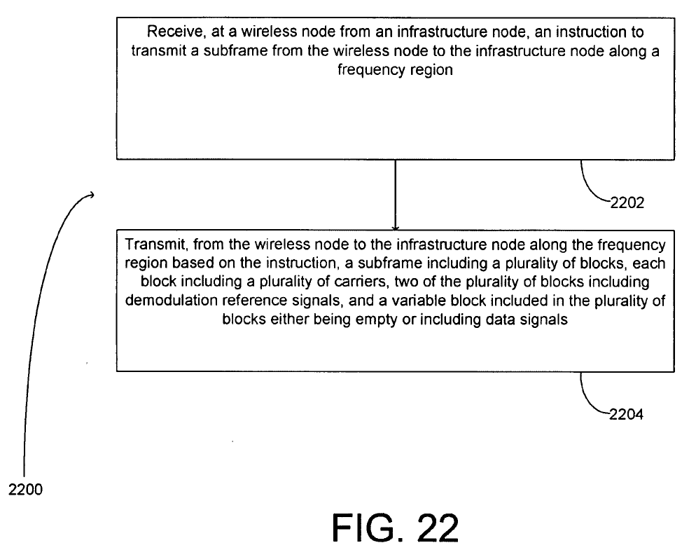

FIG. 22 is a flowchart showing a method 2200 according to another example embodiment. In this example, the method 2200 may include receiving, at a wireless node 106 from an infrastructure node 104, an instruction to transmit a subframe 200 from the wireless node 106 to the infrastructure node 104 along a frequency region (2202). The method 2200 may also include transmitting, from the wireless node 106 to the infrastructure node 104 along the frequency region based on the instruction, a subframe 200 including a plurality of blocks, each block including a plurality of subcarriers, two of the plurality of blocks including demodulation reference signals, and a variable block 1602 included in the plurality of blocks either being empty or including data signals (2204).

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including byway of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of tile described implementations have been illustrated as described herein, many modifications, substitutions, changes and equivalents will now occur to those skilled in the art.

I claim:

1. A method comprising:
determining whether to include a sounding reference signal or a demodulation reference signal within a variable block of a subframe, the subframe including a plurality of blocks; and
transmitting the subframe from a wireless node to an infrastructure node, the subframe including either the sounding reference signal or the demodulation reference signal within the variable block based on the determining.

2. The method of claim 1, wherein the determining comprises determining whether to include the sounding reference signal or the demodulation reference signal within the variable block of the subframe, the subframe including the plurality of blocks, each block including a plurality of subcarriers.

3. The method of claim 1 wherein the transmitting comprises transmitting the subframe from the wireless node to the infrastructure node, the subframe including either the sounding reference signal or the demodulation reference signal within the variable block based on the determining, the subframe also including a demodulation reference signal within a dedicated demodulation reference signal block.

4. The method of claim 1 wherein the transmitting comprises transmitting the subframe from the wireless node to the infrastructure node, the subframe including either the sounding reference signal or the demodulation reference signal within the variable block based on the determining, a demodulation reference signal within a dedicated demodulation reference signal block, and data within one or more additional blocks of the subframe.

5. The method of claim 1 wherein the subcarriers have approximately equal bandwidths.

6. The method of claim 1, wherein the determining is performed based upon an instruction received from the infrastructure node.

7. The method of claim 1 wherein the transmitting the subframe includes transmitting a plurality of subframes, the plurality of subframes including either the sounding reference signal or the demodulation reference signal in an alternating sequence.

8. The method of claim 1, wherein the transmitting the subframe includes transmitting a signal indicating whether the subframe includes the sounding reference signal or the demodulation reference signal within the variable block.

9. A method comprising:
determining, at an infrastructure node, a signal to be included within a variable block of a subframe, the signal within the variable block including either a sounding reference signal or a demodulation reference signal, the subframe including a plurality of blocks, each block including a plurality of subcarriers;
transmitting an instruction from the infrastructure node to a wireless node in a wireless network indicating the determined signal; and
receiving, at the infrastructure node from the wireless node based on the transmitting, a subframe including a plurality of blocks, each block including a plurality of subcarriers, the subframe including the determined signal in the variable block and one or more additional blocks.

10. The method of claim 9 wherein the transmitting comprises receiving the subframe at the infrastructure node from the wireless node, the subframe including the determined signal in the variable block, a demodulation reference signal within a dedicated demodulation reference signal block, and data signals within one or more blocks of the subframe.

11. An infrastructure node comprising:
a controller configured to determine a signal to be included within a variable block of a subframe, the signal within the variable block including either a sounding reference signal or a demodulation reference signal, the subframe including a plurality of blocks, each block including a plurality of subcarriers; and
a transceiver configured to:
transmit an instruction from the infrastructure node to a wireless node in a wireless network indicating the determined signal; and
receive, at the infrastructure node from the wireless node based on the transmitting, a subframe including a plurality of blocks, each block including a plurality of subcarriers, the subframe including the determined signal in the variable block and one or more additional blocks.

12. The method of claim 1 wherein the transmitting comprises receiving the subframe at the infrastructure node from the wireless node, the subframe including the determined signal in the variable block, a demodulation reference signal within a dedicated demodulation reference signal block, and data signals within one or more blocks of the subframe.

13. An apparatus comprising:
a controller configured to determine whether to include a sounding reference signal or a demodulation reference signal within a variable block of a subframe, the subframe including a plurality of blocks, each block including a plurality of subcarriers; and
a transceiver configured to transmit the subframe to an infrastructure node, the subframe including either the sounding reference signal or the demodulation reference signal within the variable block based on the determination.

14. The apparatus of claim 13 wherein the controller is configured to determine whether to include the sounding reference signal or the demodulation reference signal within the variable block of the subframe, the subframe including the plurality of blocks, each block including a plurality of subcarriers.

15. The apparatus of claim 13 wherein the transceiver is configured to transmit the subframe from the wireless node to the infrastructure node, the subframe including either the sounding reference signal or the demodulation reference signal within the variable block based on the determining, the subframe also including a demodulation reference signal within a dedicated demodulation reference signal block.

16. The apparatus of claim 13 wherein the transceiver is configured to transmit the subframe from the wireless node to the infrastructure node, the subframe including either the sounding reference signal or the demodulation reference signal within the variable block based on the determining, a demodulation reference signal within a dedicated demodulation reference signal block, and data within one or more additional blocks of the subframe.

17. The apparatus of claim 13 wherein the subcarriers have approximately equal bandwidths.

18. The apparatus of claim 13 wherein the controller is configured to determine whether to include the sounding reference signal or the demodulation reference signal within the variable block of the subframe based upon an instruction received from the infrastructure node.

19. The apparatus of claim 13 wherein the transmitting the subframe includes transmitting a plurality of subframes, the plurality of subframes including either the sounding reference signal or the demodulation reference signal in an alternating sequence.

20. The apparatus of claim 13 wherein the transmitting the subframe includes transmitting a signal indicating whether the subframe includes the sounding reference signal or the demodulation reference signal within the variable block.

21. A computer program tangibly embodied in an information carrier, the computer program being configured to cause a wireless node to:
determine whether to include a sounding reference signal or a demodulation reference signal within a variable block of a subframe, the subframe including a plurality of blocks; and
transmit the subframe from the wireless node to an infrastructure node, the subframe including either the sounding reference signal or the demodulation reference signal within the variable block based on the determining.
